(19) United States
(12) Patent Application Publication
(10) Pub. No.: US 2019/0384125 A1
(43) Pub. Date: Dec. 19, 2019

(54) DISPLAY DEVICE

(71) Applicant: Wuhan China Star Optoelectronics Technology Co., Ltd., Wuhan, Hubei (CN)

(72) Inventor: Guowei ZHA, Wuhan, Hubei (CN)

(21) Appl. No.: 15/754,572

(22) PCT Filed: Jan. 17, 2018
(86) PCT No.: PCT/CN2018/073061

§ 371 Date: Feb. 22, 2018

(30) Foreign Application Priority Data
Dec. 28, 2017 (CN) 201711458771.5

(51) Int. Cl. G02F 1/1343; G09G 3/36; G02F 1/1335; G02F 1/1368; G02B 27/22

(52) U.S. Cl. CPC G02F 1/134336; G09G 3/3648; G02F 1/133504; G09G 2320/066; G02F 1/133528; G02B 27/2214; G02F 1/1368

(57) ABSTRACT

A display device is provided. The display panel includes a liquid crystal panel; a backlight module positioned opposite to the liquid crystal panel; a liquid crystal grating positioned between the liquid crystal panel and the backlight module, the liquid crystal grating comprises a first substrate; a second substrate positioned opposite to the first substrate and between the first substrate and the backlight module; a liquid crystal filled between the first substrate and the second substrate; a first electrode positioned on a surface of the first substrate which is toward to the second substrate; a second electrode positioned on a surface of the second substrate which is toward to the first substrate, and the first electrode and/or the second electrode includes a plurality of electrode strip, each of the electrode strips is independently provides voltage.

### RELATED APPLICATIONS

The present application is a National Phase of International Application Number PCT/CN2018/073061, filed Jan. 17, 2018, and claims the priority of China Application No. 201711458771.5, filed Dec. 28, 2017.

### FIELD OF THE DISCLOSURE

The disclosure relates to a display technical field, and more particularly to a display panel could achieve to 2D/3D display and has high contrast during 2D display.

### BACKGROUND

3D display technology has become a development trend of future display technologies because of being able to reproduce the human-familiar cognitive mode in nature. Because of getting rid of complicated auxiliary devices make the naked-eye 3D technology became popular. It has many types to achieve naked-eye 3D display, such that an important development direction for naked-eye 3D display technology is that liquid crystal grating free to change 2D/3D module and not effects to resolution of 2D display while the 3D display technology is not totally replacing the 2D display.

Currently, the 2D display panel could be divided to front-mounted type and back-mounted type according to position relation of the liquid crystal grating to the 2D display panel; wherein the front-mounted type is positioning liquid crystal grating above the 2D display panel, and back-mounted type is positioning liquid crystal grating between the 2D display panel arid backlight module. The liquid crystal grating includes upper/lower substrates, a liquid crystal layer positioned between the upper/lower substrates and upper/lower polarizer, wherein the liquid crystal layer forming the bright-dark alternatively grating structure for splitting according to apply electrical voltage on different areas make the liquid crystal molecular angle have a certain distribution along the space. In the viewpoint, the liquid crystal grating is similar to the traditional grating, arrangement direction of the grating strip is parallel to the pixel structure, and constructing two viewpoint with the 2D display panel. Or using slant grating (which is the grating arrangement direction has a certain angle with the pixel arrangement), and with 2D display panel to form a multiple viewpoint design.

However, because the limitation of the currently 3D development, most of the video in the market is 3D, such that 3D display device is also needs to play 2D display most of time. The liquid crystal grating could flexible control the liquid crystal grating by voltage; it could decrease 2D display quality effect on transparent loss. In general, while play 2D display the liquid crystal grating is in useless state. It causes the liquid crystal grating which is seldom used to increases thickness of the display device, but the function aspect is be limited. Therefore, how to exploit the role of liquid crystal grating and provide the liquid crystal grating some function in the 2D display field is become an important direction.

While the resolution, the color gamut, the response time, the frame rate, and the like of the display device are gradually satisfying the needs of consumers, enhances display device contrast became an important breakthrough technologies. Corresponding to self-luminous OLED display technology, it is limited on the irregularities of the arrangement of the liquid crystal molecules and the limited polarization property of the polarizer, the dark state of the liquid crystal display device and the related contrast have disadvantages, and the present solution is achieved by a dynamic dividing backlighting method. In the large-scale liquid crystal display device field, it could be using the direct-type backlight module to achieve the dynamic dividing backlighting; in the middle/small size liquid crystal display device field which is more sensitive to thickness, edge-type backlight module has disadvantage of design the dividing backlighting. Therefore, how achieve to enhance dynamic contrast is the key issue of middle/small size liquid crystal display device.

### SUMMARY

A technical problem to be solved by the disclosure is to provide a display device could achieve to 2D/3D display and has high contrast during 2D display.

An objective of the disclosure is achieved by following embodiments. In particular, a display device includes a liquid crystal panel; a backlight module positioned opposite to the liquid crystal panel; a liquid crystal grating positioned between the liquid crystal panel and the backlight module, the liquid crystal grating comprises a first substrate; a second substrate positioned opposite to the first substrate and between the first substrate and the backlight module; a liquid crystal filled between the first substrate and the second substrate; a first electrode positioned on a surface of the first substrate which is toward to the second substrate; a second electrode positioned on a surface of the second substrate which is toward to the first substrate, and the first electrode and/or the electrode substrate includes a plurality of electrode strip, each of the electrode strips is independently provides voltage.

In an embodiment, the electrode strips of the first electrode are respectively corresponding to the electrode strips of the second electrode, which the first electrode and the second electrode both include plurality of electrode strip.

In an embodiment, the plurality of electrode strip is array arrangement, each of the electrode strips is extending along column direction of the array arrangement.

In an embodiment, the liquid crystal panel includes a plurality of pixel is array arrangement, each of the electrode strips is corresponding to at least one pixel.

In an embodiment, the electrodes are positioned at interval along row direction of the array arrangement and each of the electrode strips is extending along in column direction of the array.

In an embodiment, the liquid crystal panel includes a plurality of pixel is array arrangement, each of the electrode strips is corresponding to at least one row pixel.

In an embodiment, the liquid crystal grating further comprises a plurality of transistor, the transistors are respectively connecting to the electrode strips, each of the transistors is independently providing voltage to the correspondingly electrode strip.

In an embodiment, the liquid crystal grating further comprises an lower polarizer, the lower polarizer is positioned between the second substrate and the backlight module.

In an embodiment, the liquid crystal panel comprising a liquid crystal cell positioned opposite to the first substrate; an upper polarizer positioned on a side of the liquid crystal cell which is backward to the first substrate; a middle polarizer positioned between the liquid crystal cell and the first substrate.

In an embodiment, the backlight module is edge-lit backlight module.

In sum, the display device of this disclosure could achieve to 2D/3D display, and voltage of each of the electrode strips is independently controlled during the 2D display. Therefore, the correspondingly liquid crystal of each of the electrode strips cloud be independently controlled for passing or not passing the backlight such that could forming a backlight which has pixel level brightness and providing to the liquid crystal display. Thus, this could obviously improve display contrast of liquid crystal panel and achieve to highly motion contrast display effect.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a structural schematic view of a display panel according to an embodiment of the disclosure;

FIG. 2 is a schematic view of an arrangement of electrode strips and correspondingly relation between the electrode strip and a pixel of the liquid crystal panel according to an embodiment of the disclosure;

FIG. 3 is a schematic view of an arrangement of electrode strips and correspondingly relation between the electrode strip and a pixel of the liquid crystal panel according to another embodiment of the disclosure;

FIG. 4 is a structural schematic view of a display panel according to another embodiment of the disclosure; and

FIG. 5 is a structural schematic view of a display panel according to another embodiment of the disclosure.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

Example embodiments will be described in detail with reference to the accompanying drawings. In the drawings, the thicknesses of layers and regions may have been exaggerated for clarity. Same label of entire specification and drawing indicated the same element.

FIG. 1 is a structural schematic view of a display panel according to an embodiment of the disclosure.

Please refer to the FIG.1, the display device of the embodiment in this disclosure includes a liquid crystal device 100, a backlight module 200 and a liquid crystal grating 300.

The liquid crystal panel 100 is opposite to the liquid crystal panel 200. The liquid crystal panel 100 comprising a liquid crystal cell 110 and an upper polarizer 120, a middle polarizer 130. The upper polarizer 120 and the middle polarizer 130 are positioned opposite to two side of the liquid crystal cell 110. In this embodiment, display module of the liquid crystal cell 110 is not limited, it may be TN module, IPS module, FFS module or VA module and so on.

The liquid crystal grating 300 is positioned between the liquid crystal panel 100 and the liquid crystal panel 200. The liquid crystal grating 300 includes a first substrate 310, a second substrate 320, a liquid crystal 330, a first electrode 340 and a second electrode 350.

The first substrate 310 is positioned between the liquid crystal panel 100 and the backlight module 200, the second substrate 320 is positioned between the first substrate 310 and the backlight module 200. In this embodiment, the first substrate 310 and the second substrate 320 may be glass substrate, or may be a flexible substrate made by flexible material such as polyimide. The liquid crystal 330 is positioned between the first substrate 310 and the second substrate 320, the liquid crystal 330 includes plurality liquid crystal molecular. Here is not limited to the arrangement of the liquid crystal molecular, it could posit the arrangement of the liquid crystal molecular according to the liquid crystal grating 300.

The first electrode 340 is positioned on a surface of the first substrate 310 which is toward to the second substrate 320. The second electrode 350 is positioned on a surface of the second substrate 320 which is toward to the first substrate 310. In this embodiment, the first electrode 340 includes a plurality electrode strip DT, arid the second electrode 350 is entirely laid on the surface of the second substrate 320 which is toward to the first substrate 310.

In addition, the backlight module 200 may be edge-lit backlight module. But here is not limited thereto, for example the backlight module 200 may be direct-type backlight module.

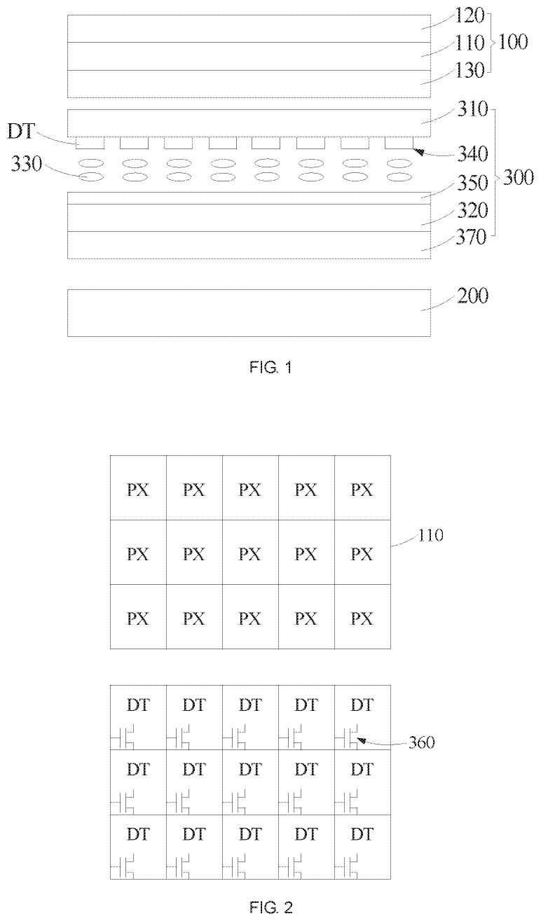

FIG. 2 is a schematic view of an arrangement of electrode strips and correspondingly relation between the electrode strip and a pixel of the liquid crystal panel according to an embodiment of the disclosure. Upper diagram of the FIG. 2 is arrangement of pixel of the liquid crystal panel; lower diagram of he FIG. 2 is arrangement of electrode strips.

Please refer to FIG. 1 and FIG. 2. The liquid crystal cell 100 of the liquid crystal panel 100 could include a plurality of pixel PX. In this embodiment, each of the pixels PX could include red sub-pixel, green sub-pixel and blue sub-pixel, but here is not limited thereto. The plurality of the pixel is array arrangement.

The plurality of electrode strip DT is array arrangement, and each of the electrode strips DT is extending along column direction of the array arrangement, and each of the electrode strips DT is independently providing voltage. Specifically, the liquid crystal grating 300 further includes a plurality of transistor 360, the transistors 360 are respectively connecting to the electrode strips DT, each of the transistors 360 is independently providing voltage to the correspondingly electrode strip DT. In this embodiment, the electrode strips DT is corresponding to one pixel PX, but here is not limited thereto. For example, the electrode strips DT may be corresponding to two, three or more pixels PX.

In addition, please refer to FIG. 1 again; the liquid crystal grating 300 further comprises a lower polarizer 370, the lower polarizer 370 is positioned between the second substrate 320 and the backlight module 200. In this embodiment, position of light-transmission axis of the upper polarizer 120, middle polarizer 130 and lower polarizer 370 is not limited. Only needs to ensure the position of light-transmission axis of these three elements could provide 2D display or 3D display. In addition, the liquid crystal grating 300 sharing middle polarizer 130 of the liquid crystal panel 100 such that decreases cost and thickness of the display device. In another embodiment, an extra polarizer is positioned between the middle polarizer 130 and the first substrate 310 of the liquid crystal grating 300.

When the display device of the embodiment in this invention displays 3D, the liquid crystal grating 300 is split light by controlling the voltage such that achieves to 3D display.

When the display device of the embodiment in this invention displays 2D, while the backlight module 300 emits the backlight, each of the electrode strips DT is independently controlled, so that each of the electrode strips DT cloud be independently controlled the liquid crystal 330 passing or not passing the backlight such that could forming a backlight which has pixel level brightness. While this backlight providing the liquid crystal panel 100 for using, it could obviously improve display contrast of liquid crystal panel and achieve to highly dynamic contrast display effect.

FIG. 3 is a schematic view of an arrangement of electrode strips and correspondingly relation between the electrode strip and a pixel of the liquid crystal panel according to another embodiment of the disclosure. Upper diagram of the FIG. 3 is arrangement of pixel of the liquid crystal panel; lower diagram of the FIG. 3 is arrangement of electrode strips.

Please refer to the FIG. 3. The difference between the FIG. 3 and the FIG. 2 is that, the electrode strips DT are positioned at interval along row direction of the array arrangement, and each of the electrode strips DT is extending along column direction of the array arrangement, each of the electrode strips DT is independently providing voltage.

Therefore, each of the electrode strips DT is corresponding to one column pixel PX, but here is not limited thereto. For example, each of the electrode strips DT may be corresponding to two columns, three columns or more columns pixel PX, but one electrode strip DT does not correspond to all of columns pixel PX.

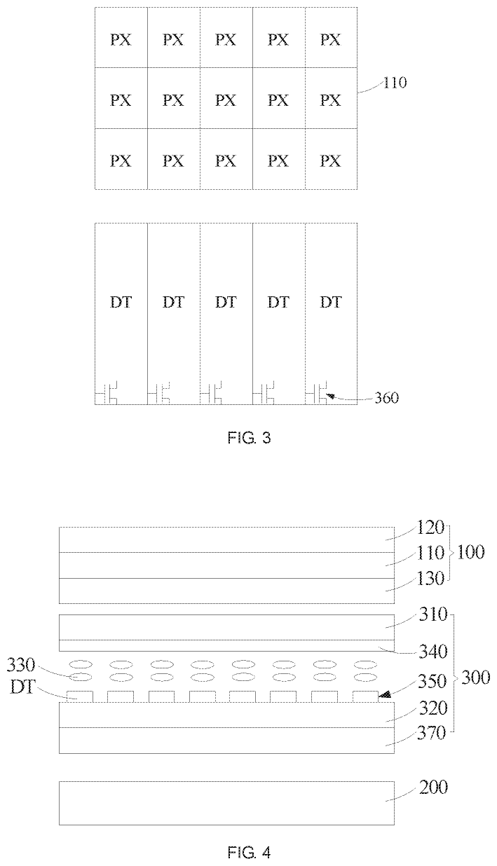

FIG. 4 is a structural schematic view of a display panel according to another embodiment of the disclosure.

Please refer to FIG. 4. The difference between the FIG. 4 and the FIG. 1 is that, the second electrode 350 includes a plurality electrode strip DT, and the first electrode 340 is entirely laid on the surface of the first substrate 310 which is toward to the second substrate 320. The arrangement of the electrode strip DT of the second electrode 350 may be illustrated as FIG. 2 or FIG. 3.

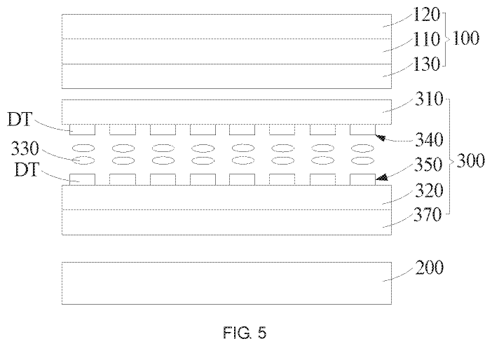

FIG. 5 is a structural schematic view of a display panel according to another embodiment of the disclosure.

Please refer to FIG. 5. The difference between the FIG. 5 and the FIG. 1 is that, the first electrode 340 and the second electrode 350 both include a plurality electrode strip DT. The arrangement of the electrode strip DT of the first electrode 340 may be illustrated as FIG. 2 or FIG. 3; and the arrangement of the electrode strip DT of the second electrode 350 also may be illustrated as FIG. 2 or FIG. 3.

In addition, in order to ensure consistently driving the liquid crystal 330, the electrode strips DT of the first electrode 340 are corresponding to the electrode strips DT of the second electrode 350.

In sum, the display device of this disclosure could achieve to 2D/3D display, and voltage of each of the electrode strips is independently controlled during the 2D display. Therefore, the correspondingly liquid crystal of each of the electrode strip cloud be independently controlled for passing or not passing the backlight such that could forming a backlight which has pixel level brightness and providing to the liquid crystal display. Thus, this could obviously improve display contrast of liquid crystal panel and achieve to highly motion contrast display effect.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should be included in the protection scope of the application.

What is claimed is:

1. A display device, comprising
a liquid crystal panel;
a backlight module positioned opposite to the liquid crystal panel;
a liquid crystal grating positioned between the liquid crystal panel and the backlight module, the liquid crystal grating comprises
a first substrate;
a second substrate positioned opposite to the first substrate and between the first substrate and the backlight module;
a liquid crystal filled between the first substrate and the second substrate;
a first electrode positioned on a surface of the first substrate which is toward to the second substrate;
a second electrode positioned on a surface of the second substrate which is toward to the first substrate, and the first electrode and/or the second electrode includes a plurality of electrode strip, each of the electrode strips is independently provides voltage.

2. The display device according to claim 1, wherein the electrode strips of the first electrode are respectively corresponding to the electrode strips of the second electrode, which the first electrode and the second electrode both include plurality of electrode strip.

3. The display device according to claim 1, wherein the plurality of electrode strip is array arrangement, each of the electrode strips is extending along column direction of the array arrangement.

4. The display device according to claim 2, wherein the plurality of electrode strip is array arrangement, each of the electrode strips is extending along column direction of the array arrangement.

5. The display device according to claim 3, wherein the liquid crystal panel includes a plurality of pixel is array arrangement; each of the electrode strips is corresponding to at least one pixel.

6. The display panel according to claim 4, wherein the liquid crystal panel includes a plurality of pixel is array arrangement; each of the electrode strips is corresponding to at least one pixel.

7. The display device according to claim 1, wherein the electrodes are positioned at interval along row direction of the array arrangement, and each of the electrode strips is extending along in column direction of the array.

8. The display device according to claim 2, wherein the electrodes are positioned at interval along row direction of the array arrangement, and each of the electrode strips is extending along in column direction of the array.

9. The display device according to claim 7, wherein the liquid crystal panel includes a plurality of pixel is array arrangement, each of the electrode strips is corresponding to at least one row pixel.

10. The display device according to claim 8, wherein the liquid crystal panel includes a plurality of pixel is array arrangement, each of the electrode strips is corresponding to at least one row pixel.

11. The display device according to claim 1, wherein the liquid crystal grating further comprises a plurality of transistor, the transistors are respectively connecting to the electrode strips, each of the transistors is independently providing voltage to the correspondingly electrode strip.

12. The display device according to claim 1, wherein the liquid crystal grating further comprises a lower polarizer, the lower polarizer is positioned between the second substrate and the backlight module.

13. The display device according to claim 11, wherein the liquid crystal grating further comprises a lower polarizer, the lower polarizer is positioned between the second substrate and the backlight module.

14. The display device according to claim 12, wherein the liquid crystal panel comprising
a liquid crystal cell positioned opposite to the first substrate;
an upper polarizer positioned on a side of the liquid crystal cell which is backward to the first substrate;
a middle polarizer positioned between the liquid crystal cell and the first substrate.

15. The display device according to claim 13, wherein the liquid crystal panel comprising
a liquid crystal cell positioned opposite to the first substrate;
an upper polarizer positioned on a side of the liquid crystal cell which is backward to the first substrate;
a middle polarizer positioned between the liquid crystal cell and the first substrate.

16. The display device according to claim 1, wherein the backlight module is edge-lit backlight module.
